(19) United States
(12) Patent Application Publication
(10) Pub. No.: US 2013/0168377 A1
(43) Pub. Date: Jul. 4, 2013

(54) ADAPTER FOR COUPLING A DIFFUSION FURNACE SYSTEM

(71) Applicants: Ying Shun Liang, Singapore (SG); Samuel Gordon McKee, Sengkang (SG)

(72) Inventors: Ying Shun Liang, Singapore (SG); Samuel Gordon McKee, Sengkang (SG)

(73) Assignee: STMicroelectronics Pte Ltd., Singapore (SG)

(21) Appl. No.: 13/339,757

(22) Filed: Dec. 29, 2011

(51) Int. Cl. F27D 11/00; B23P 11/00; F03B 11/02

(52) U.S. Cl. 219/385; 137/561 R; 29/428

(57) ABSTRACT

An adapter is provided for fluidly coupling a process chamber, such as a diffusion furnace or a process tube, and a fluid source, such as a torch chamber or combustion chamber, of a system for processing semiconductor material. The process tube and the torch chamber include joint segments that can engage directly together to fluidly couple the torch chamber to the process tube for introducing a fluid, such as an oxidizing gas or vapor, into the process tube. The process chamber and the torch chamber are formed of materials having different rates of thermal expansion. The adapter is configured to couple the joint segments of the torch chamber and the process tube while accommodating the differences in thermal expansion between the materials. The adapter may be formed of quartz to couple a quartz torch chamber with a silicon carbide process tube.

### BACKGROUND

Fabrication of a semiconductor wafer may involve the formation of a dielectric or insulating film or layer on semiconductor material, such as silicon. For example, a silicon dioxide layer may be formed on a silicon wafer via oxidation. This is generally accomplished by thermal oxidation wherein the wafer is exposed to an oxidizing environment at an elevated temperature.

Thermal oxide may be grown in a diffusion furnace or process tube, which may be oriented either vertical or horizontal, at temperatures from 800° C. to 1200° C. using either a “wet” or “dry” growth method. Wet oxides may be grown pyrogenically using hydrogen and oxygen gases that are ignited in a combustion or torch chamber to form high purity steam or water vapor that is injected or otherwise introduced into the diffusion furnace.

The use of steam or water vapor accelerates oxide growth which occurs at the silicon/oxygen interface and grows outwardly from the silicon. As the oxide grows thicker, the rate of growth decreases because it takes longer for the oxygen atoms to penetrate the oxide and reach the silicon interface where the oxygen atoms combine with the silicon atoms to form the oxide. Oxygen atoms diffuse through the formed oxide at high temperature to reach the silicon to form additional oxide. This reaction occurs faster with an increase in the temperature of the diffusion furnace or process tube.

A diffusion furnace system for processing semiconductor material typically utilizes a torch chamber formed of quartz and a process tube formed of either quartz or silicon carbide, depending on the temperature of the particular process being conducted with the system. For process temperatures greater than 900° C., such as employed for oxidation or diffusion processes, the process tube is typically formed of silicon carbide to withstand the relatively high process temperature.

### SUMMARY

One aspect of the invention is a system for processing semiconductor material. The system comprises a process chamber to process semiconductor material therein and a fluid source to introduce a process fluid into the process chamber for processing the semiconductor material. The process chamber includes a first joint segment formed of a first material having a first coefficient of thermal expansion and the fluid source includes a second joint segment formed of a second material having a second coefficient of expansion that is different from the first coefficient of expansion. The system further comprises an adapter, formed of the second material, joined to the first joint segment and the second joint segment to fluidly couple the fluid source to the process chamber.

Another aspect of the invention is a diffusion furnace system for oxidizing semiconductor material. The diffusion furnace system comprises a process tube to process semiconductor material therein and a torch chamber to generate water vapor for introduction into the process tube to create an oxidizing atmosphere for the semiconductor material. The process tube includes a ball joint segment that is formed of silicon carbide and has an orifice extending therethrough and the torch chamber includes a socket joint segment that is formed of quartz. The system further comprises an adapter, which is formed of quartz, fluidly coupling the torch chamber to the process tube. The adapter includes a first portion that extends into the orifice of the ball joint segment of the process tube and a second portion having a ball configuration engaged with the socket joint segment of the torch chamber to form a joint therebetween.

A further aspect of the invention is an adapter for fluidly coupling a torch chamber to a process tube of a diffusion furnace system for processing semiconductor material. The process tube includes a ball joint segment with an orifice and the torch chamber includes a socket joint segment that is configured to receive the ball joint segment of the process tube. The torch chamber is formed of quartz and the process tube is formed of silicon carbide. The adapter comprises an adapter body formed of quartz material and includes a throughbore extending along a length thereof. The adapter body includes a tubular portion that is adapted to be inserted into the orifice of the ball joint segment of the process tube and a ball joint segment located at an end of the tubular portion that is adapted to engage with the socket joint segment of the torch chamber to form a ball-and-socket joint therebetween.

Another aspect of the invention is a method of coupling a torch chamber to a process tube of a diffusion furnace system for processing semiconductor material. The process tube includes a male joint segment with an orifice extending therethrough and the torch chamber includes a female joint segment that is configured to receive the male joint segment, the torch chamber being formed of quartz and the process tube being formed of silicon carbide. The method comprises acts of providing an adapter body that is formed of quartz material and includes a throughbore extending along a length thereof. The adapter body includes a tubular portion and a male joint segment located at an end of the tubular portion, the male joint segment of the adapter having a configuration that mimics the male joint segment of the process tube. The method further comprises inserting the tubular portion into the orifice of the male joint segment of the process tube, and engaging the male joint segment of the adapter with the female joint segment of the torch chamber to form a joint therebetween.

### BRIEF DESCRIPTION OF THE DRAWINGS

Various embodiments of the invention will now be described, by way of example, with reference to the accompanying drawings, in which:

FIG. 1 is a partial schematic of a system for processing a semiconductor material;

FIG. 2 is a partial schematic of the system of FIG. 1 with a fluid source coupled with a process chamber;

FIG. 3 is a partial schematic of the system of FIGS. 1-2 utilizing an adapter for coupling the fluid source with the process chamber according to an embodiment of the invention;

FIG. 4 is a partial cross-sectional view taken along section line 4-4 of FIG. 3 illustrating the adapter coupling the fluid source and the process chamber;

FIG. 5 is a perspective view of an adapter according to one illustrative embodiment;

FIG. 6 is a side view of the adapter of FIG. 5; and

FIG. 7 is a cross-sectional view of the adapter taken along section line 7-7 of FIG. 6.

### DETAILED DESCRIPTION

An adapter is provided for fluidly coupling a process chamber, such as a diffusion furnace or a process tube, and a fluid source, such as a torch chamber or combustion chamber, of a system for processing semiconductor material. The process chamber, which may be a diffusion furnace and the fluid source, which may be a torch chamber, may include joint segments or connectors that are configured to be joined or connected directly together to fluidly couple the torch chamber to the furnace for introducing a fluid, such as an oxidizing gas or vapor, into the process chamber of the furnace from the torch chamber to create a suitable atmosphere within the furnace for processing the semiconductor material.

The system may include a diffusion furnace and a torch chamber that are formed of materials having different coefficients of thermal expansion. Rather than engaging with or connecting the joint segment or connector of the torch chamber directly to the joint segment or connector of the diffusion furnace, the system may include an adapter that is configured to couple the joint segments of the torch chamber and the diffusion furnace together while accommodating the differences in thermal expansion between the materials. In this manner, the adapter may substantially reduce, if not eliminate, potential stress on the joint segments of the torch chamber and the diffusion furnace that may otherwise occur were the joint segments connected directly to each other and to experience different amounts of thermal expansion therebetween during use of the system.

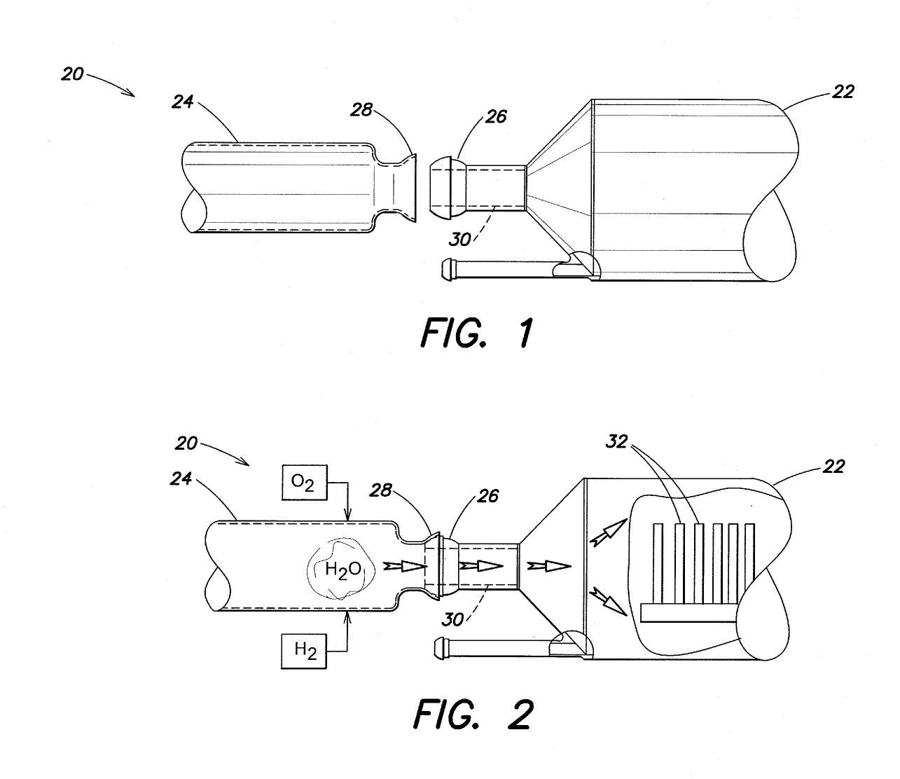

FIGS. 1-2 illustrate an embodiment of a system 20 for processing a semiconductor material. The system may include a process chamber 22 for processing semiconductor material therein and a fluid source 24 for introducing a process fluid into the process chamber. As shown, the process chamber 22 may include a first connector or joint segment 26 that is configured to engage directly with a second connector or joint segment 28 provided on the fluid source to fluidly couple the fluid source to the process chamber. An orifice 30 may extend through the first connector or joint segment 26 to pass the process fluid from the fluid source into the process chamber.

The first connector or joint segment 26 may have a male configuration and the second connector or joint segment 28 may have a female configuration that receives the male joint segment, as shown in FIG. 2. In one embodiment, the connectors or joint segments may be configured to form a ball-and-socket joint with the male connector 26 including a ball segment of the joint and the female connector 28 including a socket or cup segment of the joint. It is to be appreciated that other suitable connector or joint configurations may be implemented with the system as should be apparent to one of skill in the art.

For some applications, the process chamber 22 and the fluid source 24, including their respective connectors or joint segments 26, 28, may be formed of materials having different coefficients of thermal expansion. For example, the process chamber 22, including its joint segment 26, may be formed of a material having a coefficient of thermal expansion that is greater than the material used to form the fluid source 24 and its joint segment 28. Operating such a system at high temperatures, such as may be required for oxidation or diffusion processes for semiconductor material, can cause the ball joint segment 26 of the process chamber 22 to experience a greater amount of thermal expansion relative to the socket joint segment 28 of the fluid source 24. Such an arrangement may lead to potential damage to or failure of one or both of the joint segments due to the greater expansion of the ball joint segment within the socket joint segment.

In one embodiment, the system 20 is a diffusion horizontal furnace system for processing one or more semiconductor wafers 32, such as silicon wafers, at high temperature, for example, greater than 900° C. As known in the art, such a system may be utilized for thermal oxidation of silicon wafers 32 that results in the formation of a dielectric or insulating layer or film of silicon dioxide on each semiconductor wafer.

The fluid source may include a torch chamber 24 to generate water vapor for introduction into the process tube 22 to create an oxidizing atmosphere for the semiconductor material using a process as should be apparent to one of skill in the art. For example, hydrogen H₂ and oxygen O₂ gases may be introduced and ignited within the torch chamber 24 to produce high purity steam or water vapor H₂O that then flows into the process tube 22, such as illustrated in FIG. 2. The water vapor enters the process tube 22 where it expands and distributes throughout the tube to react with the silicon wafers 32 to form a silicon dioxide layer.

The torch chamber 24 may formed of quartz and the process tube 22 may be formed of silicon carbide, which thermally expands at a rate that is greater than quartz. This difference in thermal expansion can lead to damage or even failure of the quartz material of the torch chamber, caused by the greater expansion of the ball joint segment 26 within the socket joint segment 28, which could lead to the introduction of unwanted external air of other contaminants into the process tube. Robustness of such a furnace configuration highly depends on the skill of the personnel when setting-up and operating the system.

To substantially reduce, if not eliminate, potential damage to the joint of such a system, it may be desirable to couple the torch chamber 24 and the process tube 22 with an adapter or coupler that accommodates the differences in thermal expansion between joint segments, such as may occur with the use of different materials.

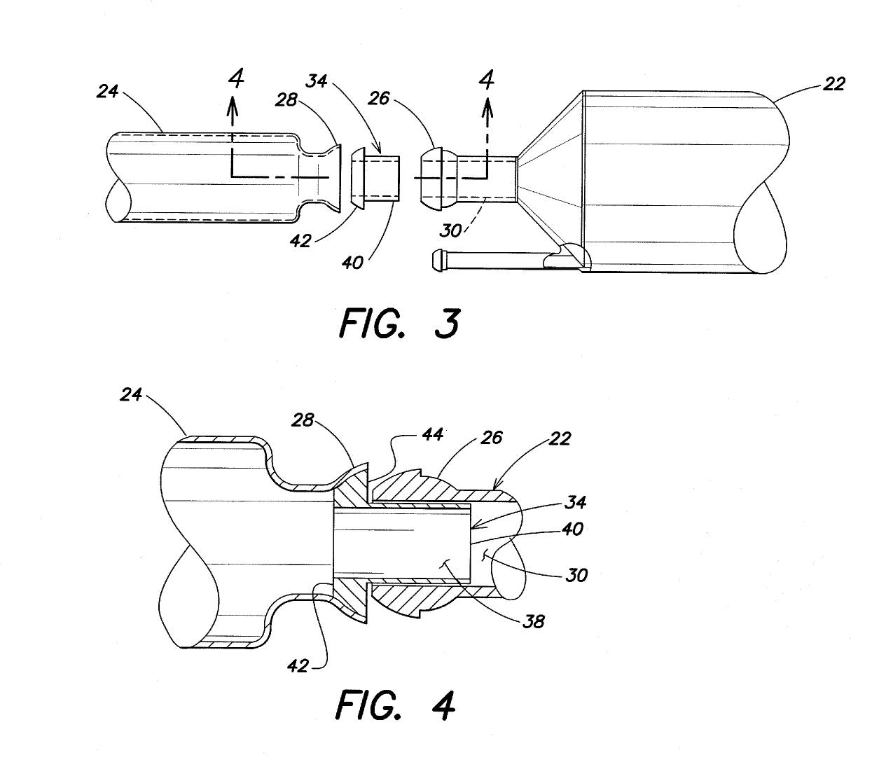

In one illustrative embodiment shown in FIGS. 3-4, a diffusion furnace system, such as the system 20 described above, may include an adapter 34 that is configured to couple the torch chamber 24 to the process tube 22. The adapter 34 may be formed of a material and/or configured in a manner that accommodates differences in thermal expansion between the joint segments of a process tube 22 and a torch chamber 24. The adapter may also be configured to couple a torch chamber 24 to a process tube 22 without impacting the design or set-up of an existing diffusion furnace system.

As illustrated in FIG. 4, the adapter 34 may be configured to engage with the socket joint segment 28 of the torch chamber 24 and to be inserted into the orifice 30 of the ball joint segment 26 of the process tube 22. In one embodiment, the adapter 34 may be formed of a quartz material to match the thermal expansion of the socket joint segment 28 of a quartz torch chamber 24. In this manner, the torch chamber 24 is not subject to the thermally expanding silicon carbide of the process tube 22. Additionally, insertion of the adapter 34 into the orifice 30 of the ball joint segment 26 of a process tube 22 formed of silicon carbide avoids the effects of the faster expanding silicon carbide material.

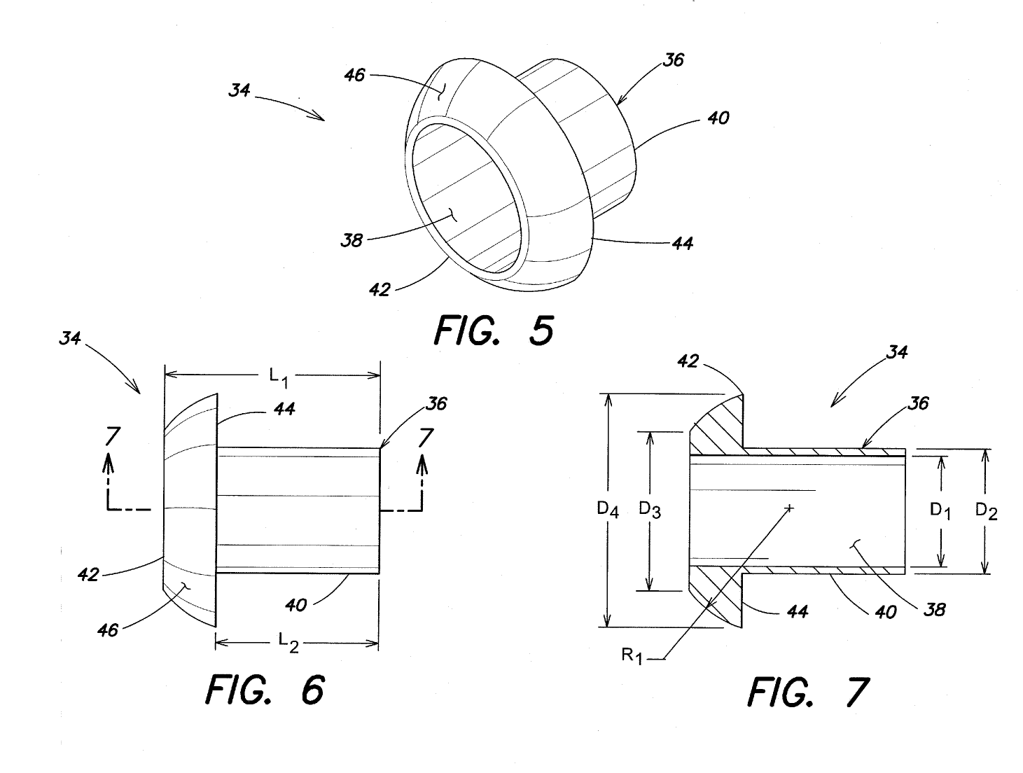

In one illustrative embodiment shown in FIGS. 5-7, the adapter 34 may include a body 36 that is configured to fluidly couple the process tube 22 and the torch chamber 24 of the system. The adapter 34 may include a throughbore 38 that extends along a length the body 36 for passing process fluid therethrough. The adapter may include a first portion 40 and a second portion 42 that are configured to engage with or otherwise connect to the process tube 22 and the torch chamber 24.

The first portion 40 may be configured to be inserted into the orifice 30 of the ball joint segment 26 of the process tube 22 so that the ball joint segment extends along the exterior of the adapter. In this manner, thermal expansion of the ball joint segment 26 that is greater than thermal expansion of the adapter 34 will create minimal, if any, stress on the adapter. In one embodiment, the first portion 40 may have a tubular configuration that fits closely within the ball joint segment 26 of the process tube and passes process fluid into the orifice.

The second portion 42 of the adapter body 34 may be configured to engage with the socket joint segment 28 of the torch chamber 24 to form a joint therebetween. In one embodiment, the second portion 42 has a ball configuration that mimics the ball joint segment 26 of the process tube 22.

The adapter 34 may be configured limit insertion of the first portion into the orifice of the process tube. In one embodiment, the adapter may include a shoulder 44 between the first and second portions that is adapted to engage an end of the ball joint segment.

The adapter 34 may employ any size and/or configuration suitable for coupling a torch chamber to a process tube of a furnace system. In one embodiment, the adapter may have a length L₁ of 55.4 mm with a throughbore 38 having a diameter D₁ of 42 mm extending along the length of the adapter. The first portion 40 of the adapter may have a tubular configuration with a length L₂ of 30 mm for insertion into the orifice of the ball joint segment of the process tube. The first portion 40 may have an outer diameter D₂ of 46 mm for insertion into an orifice that has a diameter of 50 mm. The second portion 42 of the adapter may have a ball configuration for engaging with a socket joint segment of the torch chamber. The second portion 42 may have a diameter D₃ of 50 mm at the end of the adapter that increases to a diameter D₄ of 75 mm in a direction toward the first portion of the adapter. The second portion 42 may have a spherically shaped surface 46 with a radius R₁ of 37.5 mm to form the ball joint configuration. It is to be appreciated that these dimensions are exemplary and other adapter configurations are contemplated as should be apparent to one of skill in the art.

The adapter may be fabricated from quartz material using any suitable manufacturing process as should be apparent to one of skill in the art. For example, and without limitation, the quartz adapter may be fabricated using electrical fusion or flame hydrolysis techniques. If desired, the adapter may be formed of other suitable materials using manufacturing techniques as should be apparent to one of skill in the art.

The invention has been described above in conjunction with a diffusion furnace system for oxidizing semiconductor material. However, it is to be understood that aspects of the invention may be employed with other systems for processing a semiconductor material, as should be apparent to one of skill in the art.

It should be understood that the foregoing description of various embodiments of the invention are intended merely to be illustrative thereof and that other embodiments, modifications, and equivalents of the invention are within the scope of the invention recited in the claims appended hereto. Although aspects of the invention have been described with reference to illustrative embodiments, aspects of the invention are not limited to the embodiments described. Additionally, aspects of the invention may be used alone, or in any suitable combination with other aspects of the invention.

What is claimed is:

1. A system for processing semiconductor material, the system comprising:
a process chamber to process semiconductor material therein, the process chamber including a first joint segment formed of a first material having a first coefficient of thermal expansion;
a fluid source to introduce a process fluid into the process chamber for processing the semiconductor material, the fluid source including a second joint segment formed of a second material having a second coefficient of expansion that is different from the first coefficient of expansion; and
an adapter, formed of the second material, joined to the first joint segment and the second joint segment to fluidly couple the fluid source to the process chamber.

2. The system according to claim 1, wherein the first coefficient of expansion is greater than the second coefficient of expansion.

3. The system according to claim 1, wherein the first material is silicon carbide and the second material is quartz.

4. The system according to claim 1, wherein the adapter includes a first portion that extends into an orifice of the first joint segment and a second portion that is received in the second joint segment.

5. The system according to claim 4, wherein the first joint segment has a ball configuration and the second joint segment has a socket configuration.

6. The system according to claim 5, wherein the first portion has a tubular configuration and the second portion has a ball configuration that mimics the ball configuration of the first joint segment.

7. The system according to claim 6, wherein the second portion of the adapter has a spherically-shaped surface.

8. The system according to claim 4, wherein the adapter includes a shoulder that limits insertion of the adapter into the orifice of the first joint segment.

9. The system according to claim 1, wherein the process chamber is adapted to heat the semiconductor material.

10. The system according to claim 1, wherein the fluid source includes a torch chamber adapted to pyrogenically produce the process fluid.

11. The system according to claim 10, wherein the torch chamber is adapted to produce water vapor.

12. A diffusion furnace system for oxidizing semiconductor material, the diffusion furnace system comprising:
a process tube to process semiconductor material therein, the process tube including a ball joint segment that is formed of silicon carbide and has an orifice extending therethrough;
a torch chamber to generate water vapor for introduction into the process tube to create an oxidizing atmosphere for the semiconductor material, the torch chamber including a socket joint segment that is formed of quartz; and
an adapter, which is formed of quartz, fluidly coupling the torch chamber to the process tube, the adapter including a first portion that extends into the orifice of the ball joint segment of the process tube and a second portion having a ball configuration engaged with the socket joint segment of the torch chamber to form a joint therebetween.

13. The diffusion furnace system according to claim 12, wherein the second portion of the adapter mimics the ball joint segment of the process tube.

14. The diffusion furnace system according to claim 13, wherein the second portion of the adapter has a spherically-shaped surface.

15. The diffusion furnace system according to claim 12, wherein the adapter includes a shoulder that limits insertion of the adapter into the orifice of the ball joint segment.

16. The diffusion furnace system according to claim 12, wherein the adapter includes a throughbore extending through the first and second portions.

17. An adapter for fluidly coupling a torch chamber to a process tube of a diffusion furnace system for processing semiconductor material, the process tube including a ball joint segment with an orifice and the torch chamber including a socket joint segment that is configured to receive the ball joint segment of the process tube, the torch chamber being formed of quartz and the process tube being formed of silicon carbide, the adapter comprising:
an adapter body formed of quartz material and including a throughbore extending along a length thereof, the adapter body including a tubular portion that is adapted to be inserted into the orifice of the ball joint segment of the process tube and a ball joint segment located at an end of the tubular portion that is adapted to engage with the socket joint segment of the torch chamber to form a ball-and-socket joint therebetween.

18. The adapter according to claim 17, wherein the ball joint segment of the adapter is configured to mimic the ball joint segment of the process tube.

19. The adapter according to claim 17, wherein the adapter includes a shoulder that is adapted to limit insertion of the adapter into the ball joint segment of the process tube.

20. The adapter according to claim 17, wherein the ball joint segment of the adapter has a spherically-shaped surface.

21. A method of coupling a torch chamber to a process tube of a diffusion furnace system for processing semiconductor material, the process tube including a male joint segment with an orifice extending therethrough and the torch chamber including a female joint segment that is configured to receive the male joint segment, the torch chamber being formed of quartz and the process tube being formed of silicon carbide, the method comprising acts of:
(a) providing an adapter body that is formed of quartz material and includes a throughbore extending along a length thereof, the adapter body including a tubular portion and a male joint segment located at an end of the tubular portion, the male joint segment of the adapter having a configuration that mimics the male joint segment of the process tube;
(b) inserting the tubular portion into the orifice of the male joint segment of the process tube; and
(c) engaging the male joint segment of the adapter with the female joint segment of the torch chamber to form a joint therebetween.

22. The method of claim 21, wherein each of the male joint segments has a ball-like configuration.

23. The method of claim 22, wherein each of the male joint segments has a spherically-shaped surface.

24. The method of claim 22, wherein the female segment has a socket-like configuration.

25. The method of claim 24, wherein act (c) includes forming a ball-and-socket joint between the male joint segment of the adapter and the female joint segment of the torch chamber.

26. The method of claim 21, wherein act (b) limiting insertion of the into the orifice with a shoulder provided on the adapter.
